(19) United States
(12) Patent Application Publication
(10) Pub. No.: US 2025/0086442 A1
(43) Pub. Date: Mar. 13, 2025

(54) SCALABLE DISTRIBUTED NEURAL PROCESSING NETWORK

(71) Applicant: Ambiq Micro, Inc., Austin, TX (US)

(72) Inventor: Igor KOMIR, Spicewood, TX (US)

(21) Appl. No.: 18/464,500

(22) Filed: Sep. 11, 2023

(51) Int. Cl. G06N 3/063

(52) U.S. Cl. CPC G06N 3/063

(57) ABSTRACT

A system for achieving scalable distributed processing includes a plurality of processing units, where two or more of the processing units are electrically coupled to each other. Each of the processing units further include a host processor, a coprocessor, and random-access memory. Each of the processing units are configured to receive a data request and determine whether at least a portion of the data request should be processed by one or more of the remaining processing units. Each of the processing units are also configured to transfer at least a portion of the data request to one or more of the remaining processing units in response to determining that the at least a portion of the data request should be processed by one or more of the remaining processing units.

### FIELD OF THE INVENTION

The present invention relates generally to computing devices, and more specifically, to scalable networks of distributed processing units.

### BACKGROUND OF THE INVENTION

One of the persistent goals in the field of electronics is the miniaturization of the physical electrical components used. As the size of these physical electrical components continues to decrease, the components themselves may be implemented in a greater number of devices or systems. The overall footprint of the devices or systems that implement these smaller physical components has reduced as well, thereby allowing for the further miniaturization of electrical devices.

While various types of electronic components continue to be miniaturized, some components have reached a limit in terms of what is achievable. This limit is defined by the technology used to form the electronic components, and often cannot be overcome without experiencing significant reductions in performance. For example, flash memory cells cannot currently be manufactured below 28 nanometers (nm). Below this limit, conventional flash manufacturing procedures are unable to produce physical electrical components that function accurately, predictably, and efficiently in a desired environment. This has an impact on where certain types of memory, like flash memory, can be implemented.

These limitations cause physical electrical components to be implemented in systems and connected to each other in inefficient ways. For example, a size limitation for a particular physical electrical component may result in using longer connections to other physical electrical components. This leads to inefficiencies in areas including information transfer, power consumption, and processing throughput. As a result, conventional products have been limited from improving performance.

### SUMMARY OF THE INVENTION

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to certain aspects of the present disclosure, a system for achieving scalable distributed processing includes a plurality of processing units logically coupled to each other, at least some of which are also electrically coupled to each other. Each of the processing units further include a host processor, a coprocessor, and random-access memory. Each of the processing units are configured to receive a data request and determine whether at least a portion of the data request should be processed by one or more of the remaining processing units. Each of the processing units are also configured to transfer at least a portion of the data request to one or more of the remaining processing units in response to determining that the at least a portion of the data request should be processed by one or more of the remaining processing units.

According to other aspects of the present disclosure, a method for achieving scalable distributed processing includes receiving a data request at a given one of a plurality of processing units. Each of the plurality of processing units are logically coupled to each other, and at least some of the processing units are also electrically coupled to each other. Moreover, each of the processing units includes: a host processor, a coprocessor, and random-access memory. The method further includes determining whether at least a portion of the data request should be processed by one or more of the remaining processing units. In response to determining that at least a portion of the data request should be processed by one or more of the remaining processing units, the portion of the data request is transferred to one or more of the remaining processing units.

According to still other aspects of the present disclosure, a non-transitory computer readable medium has software instructions stored thereon. The software instructions, when executed by a processor of a given one of a plurality of processing units, cause the processor of the given processing unit to: receive, by the given processing unit, a data request. The plurality of processing units are logically coupled to each other, and at least some of the processing units are also electrically coupled to each other, e.g., by a parallel bus. Moreover, each of the processing units includes a host processor, a coprocessor, and random-access memory. The software instructions further cause the processor to determine, by the given processing unit, whether at least a portion of the data request should be processed by one or more of the remaining processing units. In response to determining that at least a portion of the data request should be processed by one or more of the remaining processing units, the portion of the data request is transferred to one or more of the remaining processing units via the parallel bus.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

For instance, the following description discloses several illustrative implementations of systems that have achieved scalable distributed processing, as well as the operation and/or component parts thereof. This scalable distribution is achieved as a result of implementing a plurality of processing units in a meshed configuration that allows for operations to be distributed among any desired number of the processing units. Accordingly, operations (or at least sub-operations) may effectively be passed through the mesh such that processing units are assigned subsets of the operations to perform. It follows that this mesh configuration creates a logical/informational coupling by sending information (e.g., messages) to the remainder of the mesh through neighboring processing units. In some implementations, the first processing unit with sufficient resources available may be assigned one or more operations for processing. This may allow for complex (e.g., large) commands to be performed in a shortest amount of time by minimizing latency. However, in other implementations, certain types of operations (or sub-operations) may be assigned to certain ones of the processing units. For instance, certain ones of the processing units may be logically and/or physically configured differently than other ones of the processing units.

Depending on the implementation, the various processing units may be coupled to each other in several different ways to achieve this mesh. For instance, at least some of the processing units may be physically coupled to each other using any desired type of conductive path, e.g., such as metal wire(s), conductive vias, etc. However, it is preferred in most implementations that at least some of the processing units are coupled to each other logically. In other words, each of the processing units may only be physically electrically connected to processing units that are directly adjacent thereto, but all the processing units are connected to each other logically. This allows for the processing units to communicate with each other without physically connecting each processing unit to each of the remaining processing units. This significantly improves operating efficiency, simplifies design, and reduces cost, e.g., as will be described in further detail below.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIG. 1A is a block diagram illustrating an example of a low-power microcontroller system, according to aspects of the present disclosure.

FIG. 1B is a continuation of the block diagram of FIG. 1A.

FIG. 1C is a continuation of the block diagram of FIG. 1B.

FIG. 2 is a block diagram illustrating an example of an analog module that supplies power, external signals, and clock signals to the low-power microcontroller system of FIGS. 1A-1C, according to aspects of the present disclosure.

FIG. 3 is a representational view of a system having a distributed processing module, according to aspects of the present disclosure.

FIG. 4 is a flowchart of a method, according to aspects of the present disclosure.

### DETAILED DESCRIPTION

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

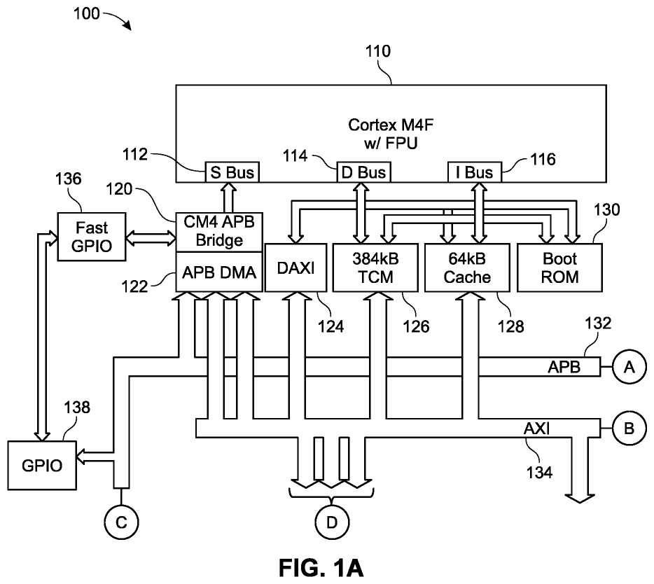

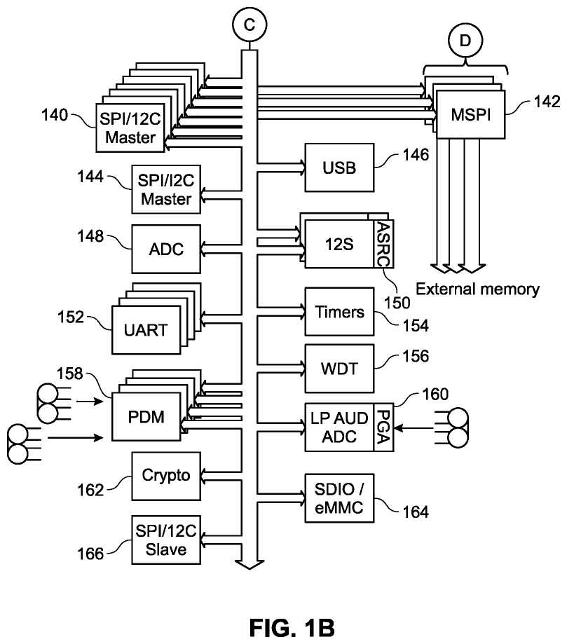

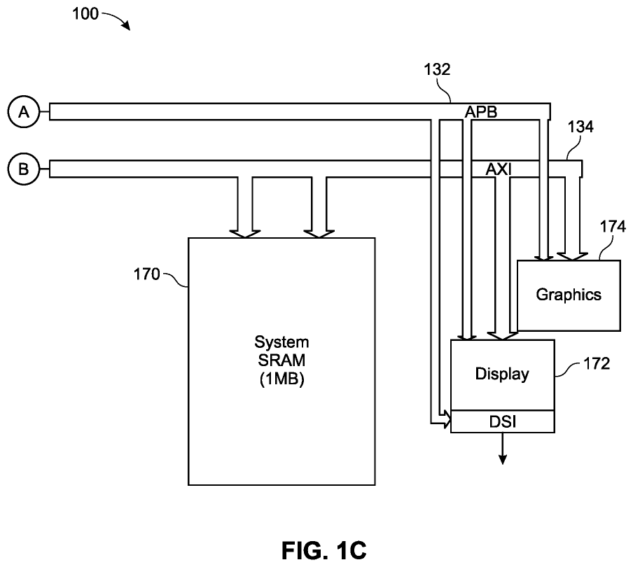

FIGS. 1A-1C show a block diagram of an exemplary low-power microcontroller system 100, in accordance with one implementation. As an option, the present system 100 may be implemented in conjunction with features from any other embodiment listed herein, such as those described with reference to the other FIGS. However, such system 100 and others presented herein may be used in various applications and/or in permutations which may or may not be specifically described in the illustrative embodiments listed herein. Further, the system 100 presented herein may be used in any desired environment. Thus FIGS. 1A-1C (and the other FIGS.) may be deemed to include any possible permutation.

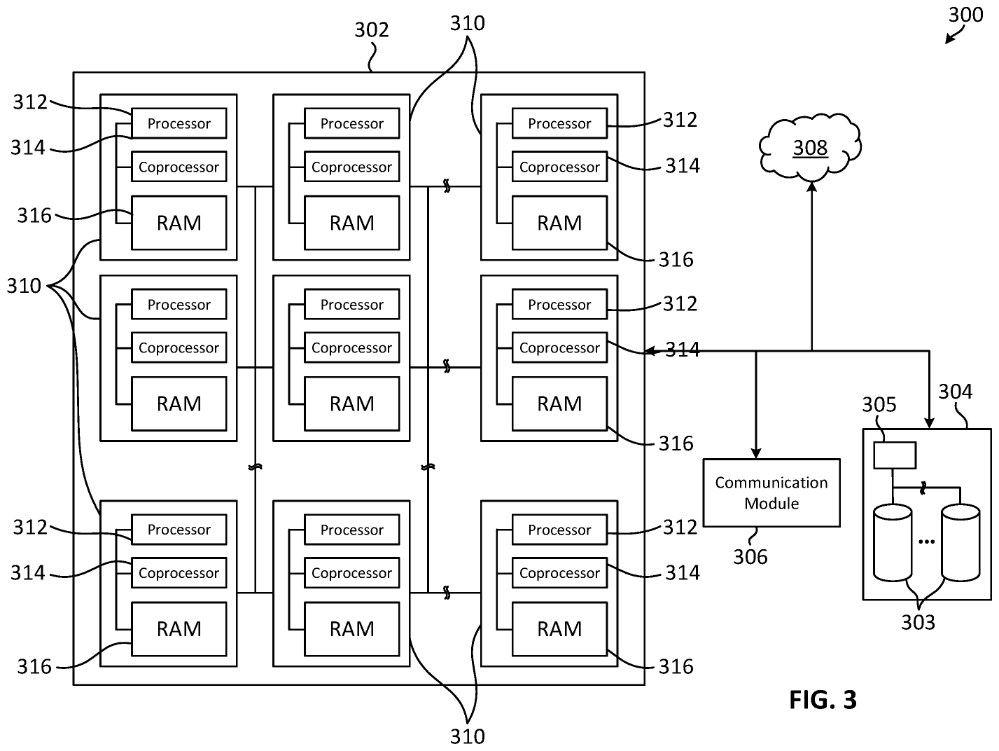

As shown, the exemplary low-power microcontroller system 100 includes a central processing unit (CPU) 110. In some examples, the CPU 110 is a Cortex M4F (CM4) with a floating-point unit, but may include any other type of processing device that would be apparent to one skilled in the art after reading the present description. For instance, the CPU 110 may actually include a scalable distributed neural processing network according to any of the implementations included herein. In one example, the CPU 110 may include a plurality of distributed and scalable processing units that form a neural network (e.g., see distributed processing module 302 of FIG. 3 below). It is also to be understood that other types of general CPUs, and/or other processors like DSPs and/or NPUs may incorporate at least some of the aspects described herein.

Referring still to FIG. 1, the CPU 110 is shown as including a System-bus interface 112, a Data-bus interface 114, and an Instruction-bus interface 116. The System-bus interface 112 is coupled to a Cortex CM4 advanced peripheral bus (APB) bridge 120 that is coupled to an advanced peripheral bus (APB) direct memory access (DMA) module 122. The microcontroller system 100 includes a Data Advanced eXtensible Interface (DAXI) 124, a tightly coupled memory (TCM) 126, a cache 128, and a boot read only memory (ROM) 130. The Data-bus interface 114 allows access to the DAXI 124, the TCM 126, the cache 128, and the boot ROM 130. The Instruction-bus interface 116 allows access to the TCM 126, the cache 128, and the boot ROM 130. In this example, the DAXI interface 124 provides write buffering and caching functionality for the microcontroller system 100. The DAXI interface 124 improves performance when accessing peripherals like the SRAM and the MSPIs.

An APB 132 and an Advanced eXtensible Interface (AXI) bus 134 are provided for communication between components on the microcontroller system 100. The APB (Advanced Peripheral Bus) is a low speed and low overhead interface that may be used for communicating with peripherals and registers that do not involve high performance and which change infrequently (e.g., when a controller wants to set configuration bits for a serial interface). However, the AXI bus 134 is preferably an Advanced Reduced Instruction Set Computer (RISC) Machines standard bus protocol (referred to as the ARM bus protocol) that allows high speed communications between multiple masters and multiple busses. This is useful for peripherals that exchange large amounts of data, such as a controller that talks to an analog to digital converter (ADC) and is tasked to transfer ADC readings to a microcontroller or a GPU that communicates with a memory and transfers large amounts of graphics data to and/or from the memory.

A fast general-purpose input/output (GPIO) module 136 is coupled to the APB bridge 120. A GPIO module 138 is coupled to the fast GPIO module 136. The APB bus 132 is coupled to the GPIO module 138. The APB bus 132 is coupled to a series of Serial Peripheral Interface/Inter-Integrated Circuit (SPI/I2C) interfaces 140 and a series of Multi-bit Serial Peripheral Interfaces (MSPI)s 142. The MSPIs 142 are also coupled to the AXI bus 134 and provide access to external memory devices.

The APB bus 132 also is coupled to a SPI/I2C interface 144, a universal serial bus (USB) interface 146, an ADC 148, an Integrated Inter-IC Sound Bus (I2S) interface 150, a set of Universal Asynchronous Receiver/Transmitters (UART)s 152, a timers module 154, a watch dog timer circuit 156, a series of pulse density modulation (PDM) interfaces 158, a low power audio ADC 160, a cryptography module 162, a Secure Digital Input Output/Embedded Multi-Media Card (SDIO/eMMC) interface 164, and a SPI/I2C slave interface module 166. The PDM interfaces 158 may be connected to external digital microphones. The low power audio ADC 160 may be connected to an external analog microphone through internal programmable gain amplifiers (PGA).

A system non-volatile memory (NVM), which may be about 2 MB in size in one example (but could be larger or smaller in other examples), is accessible through the AXI bus 134. A system static random-access memory (SRAM) 170, which may be about 1 MB in one example (but could be larger or smaller in other examples) is accessible through the AXI bus 134. The microcontroller system 100 includes a display interface 172 and a graphics interface 174 that are coupled to the APB bus 132 and the AXI bus 134.

Components of the disclosed microcontroller system 100 may further include aspects of any of the approaches, implementations, examples, etc., described by U.S. Provisional Ser. No. 62/557,534, titled “Very Low Power Microcontroller System,” filed Sep. 12, 2017; U.S. application Ser. No. 15/933,153, filed Mar. 22, 2018 titled “Very Low Power Microcontroller System,” (Now U.S. Pat. No. 10,754,414), U.S. Provisional Ser. No. 62/066,218, titled “Method and Apparatus for Use in Low Power Integrated Circuit,” filed Oct. 20, 2014; U.S. application Ser. No. 14/855,195, titled “Peripheral Clock Management,” (Now U.S. Pat. No. 9,703,313), filed Sep. 15, 2015; U.S. application Ser. No. 15/516,883, titled “Adaptive Voltage Converter,” (Now U.S. Pat. No. 10,338,632), filed Sep. 15, 2015; U.S. application Ser. No. 14/918,406, titled “Low Power Asynchronous Counters in a Synchronous System,” (Now U.S. Pat. No. 9,772,648), filed Oct. 20, 2015; U.S. application Ser. No. 14/918,397, titled “Low Power Autonomous Peripheral Management,” (Now U.S. Pat. No. 9,880,583), filed Oct. 20, 2015; U.S. application Ser. No. 14/879,863, titled “Low Power Automatic Calibration Method for High Frequency Oscillators,” (Now U.S. Pat. No. 9,939,839), filed Oct. 9, 2015; U.S. application Ser. No. 14/918,437, titled “Method and Apparatus for Monitoring Energy Consumption,” (Now U.S. Pat. No. 10,578,656), filed Oct. 20, 2015; U.S. application Ser. No. 17/081,378, titled “Improved Voice Activity Detection Using Zero Crossing Detection,” filed Oct. 27, 2020, U.S. application Ser. No. 17/081,640, titled “Low Complexity Voice Activity Detection Algorithm,” filed Oct. 27, 2020, all of which are hereby incorporated by reference.

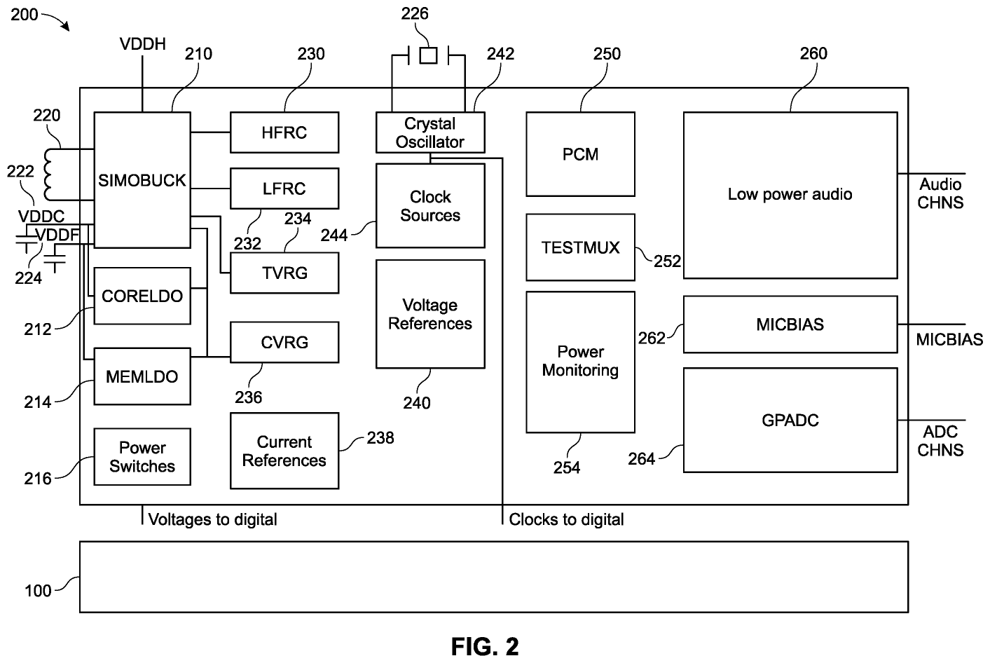

FIG. 2 shows a block diagram of an analog module 200 that interfaces certain components with the microcontroller system 100 in FIGS. 1A-1C. The analog module 200 supplies power to different components of the microcontroller system 100 as well as providing clocking signals to the microcontroller system 100. The analog module 200 includes a Single Inductor Multiple Output (SIMO) buck converter 210, a core low drop-out (LDO) voltage regulator 212, and a memory LDO voltage regulator 214. The LDO voltage regulator 212 supplies power to processor cores of the microcontroller system 100, while the memory LDO voltage regulator 214 supplies power to volatile memory devices of the microcontroller system 100 such as the SRAM 170. A switch module 216 represents switches that allow connection of power to the different components of the microcontroller system 100.

The SIMO buck converter module 210 is coupled to an external inductor 220. The module 200 is coupled to a Voltage dipolar direct core (VDDC) capacitor 222 and a voltage dipolar direct flash (VDDF) capacitor 224. The VDDC capacitor 222 smooths the voltage output of the core LDO voltage regulator 212 and the SIMO buck converter 210. The VDDF capacitor 224 smooths the voltage output of the memory LDO voltage regulator 214 and the SIMO buck converter 210. The module 200 is also coupled to an external crystal 226.

The SIMO buck converter 210 is coupled to a high frequency reference circuit (HFRC) 230, a low frequency reference circuit (LFRC) 232, and a temperature voltage regulator (TVRG) circuit 234. The HFRC provides all the primary clocks for the high frequency digital processing blocks in the microcontroller system 100 except for audio, radio and high power mode clocks. In this example, the LFRC oscillator includes a distributed digital calibration function similar to that of the external oscillator. A compensation voltage regulator (CVRG) circuit 236 is coupled to the SIMO buck converter 210, the core LDO voltage regulator 212, and the memory LDO voltage regulator 214. Thus, both trim compensation and temperature compensation are performed on the voltage sources. A set of current reference circuits 238 is provided as well as a set of voltage reference circuits 240. The reference circuits 238 and 240 provide stable and accurate voltage and current references, allowing the maintenance of precise internal voltages when the external power supply voltage changes.

In some examples, the LDO voltage regulators 212 and 214 are used to power up the microcontroller system 100. The more efficient SIMO buck converter 210 is used to power different components on demand.

A crystal oscillator circuit 242 is coupled to the external crystal 226. The crystal oscillator circuit 242 provides a drive signal to a set of clock sources 244. The clock sources 244 include multiple clocks providing different frequency signals to the components on the microcontroller system 100. In this example, three clocks at different frequencies may be selectively coupled to drive different components on the microcontroller system 100.

The analog module 200 also includes a process control monitoring (PCM) module 250 and a test multiplexer 252. Both the PCM module 250 and the test multiplexer 252 allow testing and trimming of the microcontroller system 100 prior to shipment. The PCM module 250 includes test structures that allow programming of the compensation voltage regulator 236. The test multiplexer 252 allows trimming of different components on the microcontroller system 100. The analog module 200 includes a power monitoring module 254 that allows power levels to different components on the microcontroller system 100 to be monitored. The power monitoring module 254 in this example includes multiple state machines that determine when power is required by different components of the microcontroller system 100. The power monitoring module 254 works in conjunction with the power switch module 216 to supply appropriate power when needed to the components of the microcontroller system 100. The analog module 200 includes a low power audio module 260 for audio channels, a microphone bias module 262 for biasing external microphones, and a general-purpose analog to digital converter 264.

Referring now to other aspects of the present disclosure, real-world applications involve different levels of computational overhead. For instance, depending on the specific context of applications being implemented, a processing component may receive a range of different workloads. As noted above, conventional implementations have suffered from inefficiencies resulting from physical designs controlled by manufacturing limitations. For example, certain types of memory have reached a limit on how small the physical components can be made, which has prevented further miniaturization of such components. As processing power improves, the communication paths that connect this memory to the components that are actually processing the information stored in the memory (e.g., processors) become a consistently narrowing bottleneck.

In sharp contrast, various ones of the implementations included herein have been able to overcome these conventional setbacks and achieve significant improvements to computational efficiency of the resulting system, as will be described in further detail below. Increasing computational efficiency can also increase power consumption efficiency. In other words, a greater number of computational operations can be performed in the same amount of time, while also using less power than has been conventionally achievable. It follows that improvements experienced as a result of implementing various ones of the approaches herein are particularly desirable in implementations configured to operate in limited (low) power situations.

Looking now to FIG. 3, a system 300 for achieving scalable distributed processing is illustrated in accordance with one implementation. As an option, the present system 300 may be implemented in conjunction with features from any other embodiment listed herein, such as those described with reference to the other FIGS., such as FIGS. 1A-1C. However, such system 300 and others presented herein may be used in various applications and/or in permutations which may or may not be specifically described in the illustrative embodiments listed herein. Further, the system 300 presented herein may be used in any desired environment. Thus FIG. 3 (and the other FIGS.) may be deemed to include any possible permutation.

As shown, the system 300 includes a distributed processing module 302 that is electrically connected to a memory module 304 and a communication module 306. The memory module 304 further includes data storage devices 303 (physical memory) that are connected to a local storage controller 305. The storage controller 305 may be used to manage the data storage devices 303 and the data stored therein. The storage controller 305 may also communicate (e.g., send and/or receive instructions, data, commands, requests, etc.) with the various processing units 310, other systems connected over network 308, components connected by the communication module 306, etc.

The type and/or size (e.g., storage capacity) of the memory components that are included in memory 304 may vary depending on the implementation. For instance, in some implementations the memory 304 may be configured as a cache that accumulates requests that are directed to the distributed processing module 302. In other words, the memory 304 may be used to accumulate operations, requests, etc., that are received over the network 308 and/or the communication module 306. These accumulated items can then be directed to the distributed processing module 302 for implementation. In other implementations, the memory 304 may store a copy of data that a received operation, request, instruction, etc. may pertain to. For instance, the memory 304 may be configured to store operational data received from one or more sensors (e.g., over network 308), and the distributed processing module 302 may be able to access the operational data in memory 304. Accordingly, the operational data may be processed significantly more efficiently than has been conventionally achievable.

In some implementations, the communication module 306 is a communication bus configured to connect the distributed processing module 302 and/or memory module 304 to any desired number of other components, sub-systems, modules, etc. (e.g., see APB 132 and AXI bus 134 of FIGS. 1A-1C). The communication module 306 may also be configured to facilitate (e.g., establish, monitor, maintain, etc.) a connection over the network 308. The network 308 may be of any type, e.g., depending on the desired approach. For instance, in some approaches, the network 308 is a WAN, e.g., such as the Internet. However, an illustrative list of other network types which network 308 may implement includes, but is not limited to, a LAN, a PSTN, a SAN, an internal telephone network, etc. Accordingly, the distributed processing module 302 may be able to communicate (exchange information, commands, data, instructions, etc.) with various locations, systems, running applications, etc., regardless of the amount of separation which exists therebetween, e.g., despite being positioned at different geographical locations.

Looking to the distributed processing module 302, a plurality of processing units 310 are included. As shown, each processing unit 310 may be electrically coupled to adjacent processing units 310. For instance, adjacent ones of the processing units 310 may be electrically coupled to each other using any desired type of conductive path, e.g., such as metal wire(s), conductive vias, etc. However, it is preferred in most implementations that at least some of the processing units are coupled to each other logically. In other words, while each of the processing units 310 may only be electrically connected to processing units 310 that are directly adjacent thereto, all of the processing units 310 in the distributed processing module 302 may also be connected to each other logically. As a result, the processing units 310 form a mesh that allows the processing units 310 to communicate with each other (e.g., exchange information (e.g., data, metadata, etc.), commands, instructions, etc.) without each processing unit 310 being physically connected to each of the remaining processing units 310. In some embodiments, such a configuration can improve operating efficiency, simplify design, and reduce cost of the system 100.

The logical mesh formed by the processing units 310 in the distributed processing module 302 improves operating efficiency by achieving scalable distributed processing. This meshed configuration allows for operations to be distributed among any desired number of the processing units 310, thereby making the size and capabilities of a given implementation completely scalable and distributed. Accordingly, operations (or sub-operations) may effectively be passed through the mesh such that processing units 310 are assigned subsets of the operations to perform based on characteristics of the processing unit(s) 310, the types of operations being assigned, a current processing overhead, user input, etc.

This mesh configuration creates a logical/informational coupling by sending information (e.g., messages) to the remainder of the mesh through neighboring processing units. In some implementations, the first processing unit with sufficient resources available may be assigned one or more operations for processing. This may allow for complex (e.g., large) commands to be performed in a shortest amount of time by minimizing latency. However, in other implementations, certain types of operations (or sub-operations) may be assigned to certain ones of the processing units. For instance, certain ones of the processing units may be logically and/or physically configured differently than other ones of the processing units. According to an example, one or more of the processing units 310 may be configured as a central controller for the logical mesh formed by the various processing units 310. In another example, the processing units 310 may be able to communicate with each other over the logical mesh such that operations of a larger request may be assigned to different ones of the processing units 310 without experiencing duplication.

However, in some implementations, each processing unit 310 may be electrically coupled to each of the remaining processing units 310. Accordingly, the processing units 310 may be able to communicate with each other directly. The processing units 310 may be coupled still differently in other implementations. It should also be noted that “electrically coupled” as used herein is intended to refer to any electrically conductive connection that is able to link two or more locations such that they are configured to transfer information therebetween, e.g., in the form of electrical signals. For instance, at least some of the processing units 310 may be coupled to each other using a wireless connection, e.g., WiFi, Bluetooth, a cellular network, etc.; a wired connection, e.g., a cable, a fiber-optic link, a wire, etc.; etc., or any other type of connection which would be apparent to one skilled in the art after reading the present description.

As shown, each of the processing units 310 further includes a respective host processor 312, coprocessor 314, and random-access memory 316. Including a host processor 312 and coprocessor 314 on each of the processing units 310 allows for the host processor 312 and coprocessor 314 to communicate across each of the processing units 310 in parallel. As a result, incoming requests can be distributed across the processing module 302 as desired, and the requests are processed more efficiently as a result.

Implementing a processor 312, coprocessor 314, and random-access memory 316 in each of the processing units 310 is achieved in preferred approaches by positioning (e.g., co-packing) at least two of the respective components 312, 314, 316 on the same die during the manufacture process. This allows for decreased data transmission times and increased overall throughput of the system, e.g., as would be appreciated by one skilled in the art after reading the present description. For instance, at least some (an in some embodiments, all) of the processing units 310 in the processing module 302 are electrically coupled to each other by a parallel bus.

In some approaches, the random-access memory 316 includes one or more types of non-volatile random access memory (NVRAM) and/or volatile random access memory (e.g., DRAM, SRAM, etc.). The type of NVRAM and/or volatile random access memory implemented in one of more of the processing units 310 may vary depending on the implementation. For instance, in some embodiments, the random-access memory 316 does not include flash memory therein. As noted above, the current physical limits of flash memory can be overcome by avoiding the use of flash memory. However, it should be noted that, in some embodiments, the random-access memory 316 of some, or all, of the processing units 310 can include flash memory.

In embodiments in which the random-access memory 316 does not include flash memory, the random-access memory 316 may include one or more of magnetoresistive random-access memory (MRAM), resistive random-access memory (RRAM), phase change memory, or any other type of random-access memory that would be apparent to one skilled in the art after reading the present description. As a result, the processor 312, coprocessor 314, and memory 316 can be co-packed on the same manufacturing die. This allows for a bus to connect the various dies, thereby improving the transmission times and overall throughput of the system. However, it should also be noted that some implementations may use different types of memory in the processing units 310.

It follows that the physical memory cells in the random-access memory 316 may be configured differently depending on the implementation. For instance, in some implementations the memory cells in the random-access memory 316 of one of more of the processing units 310 may be configured as analog multi-bit storage elements. This configuration is preferred in some approaches by providing a higher achievable memory density for the random-access memory 316.

In other implementations, the cells in the NVRAM of the random-access memory 316 are configured as analog adders and/or multipliers. In still other implementations, the cells in the NVRAM of the random-access memory 316 are configured as one or more computing elements that would be apparent to one skilled in the art after reading the present description. In some implementations, the cells in the NVRAM analog multi-bit storage elements may be configured as having more than one characteristic at the same time (e.g., in parallel). For example, the cells in the NVRAM may be configured as analog multi-bit storage elements in addition to being configured as computing elements in parallel.

With continued reference to FIG. 3, the processor 312 may function as a central processing unit for the respective processing unit 310. Moreover, coprocessor 314 may function as a supplemental neural processor to the main processor 312. Processor 312 may thereby be used to process certain portions and/or types of incoming requests, application steps, etc., while the coprocessor 314 is used to perform processes corresponding to neural processing.

While the processor 312, coprocessor 314, and random-access memory 316 are numbered the same for each of the processing units 310, the processing units 310 may be configured differently from each other in some implementations. For instance, some of the processing units 310 may have a host processor and/or coprocessor with a higher achievable computational throughput than other ones of the processing units 310. It follows that certain characteristics (e.g., strengths) of the various processing units 310 in a given system may be taken into consideration when internally distributing a particular task.

For example, a larger portion of a computational step being performed by the distributed processing module 302 may intentionally be routed to processing units 310 having a higher computational throughput before those processing units having a relatively lower computational throughput. Similarly, computational steps that involve accessing memory may be selectively routed to ones of the processing units 310 that have higher performing memory (e.g., RAM), while computational steps that are less memory intensive are selectively routed to processing units 310 having relatively lower performing memory (e.g., SSDs).

To achieve these varied performance capabilities, one or more of the processing units may be physically configured differently than a remainder of the processing units. In other words, each of the one or more processing units 310 may be physically configured in a particular way such that they are able to perform specialized portions of data requests. For instance, some of the processing units 310 may have a host processor and/or coprocessor with a higher achievable computational throughput than other ones of the processing units 310. In another example, some of the processing units 310 may have a larger and/or different type of memory 316 than other ones of the processing units 310.

Additionally, the processing units 310 are able to communicate with each other, e.g., as described above. It follows that the various coprocessors 314 are interconnected in preferred implementations and may thereby form at least a portion of a distributed neural network. Neural networks are a subset of machine learning that incorporate different layers of nodes (e.g., artificial neurons) that are connected to each other. Accordingly, each of the processing units 310 may function as an individual node in a larger distributed neural network that is implemented in the distributed processing module 302. Processing units 310 configured as having a neural processor may thereby include partitioned circuits that include control and/or arithmetic logic components associated with executing machine learning algorithms. These processing units 310 are preferably designed to accelerate the performance of common machine learning tasks, e.g., such as image classification, machine translation, object detection, and various other predictive models.

The system 300 is preferably configured to distribute tasks across the various processing units 310 of the distributed neural network. Moreover, tasks may be distributed such that each processing unit 310 is able to perform a portion of a total assigned workload simultaneously and in parallel. This improves operational efficiency by providing a system capable of providing adjustable computational throughput. It follows that the number of processing units 310 a given task is distributed across may vary depending on several factors.

For instance, the amount of computational overhead associated with a particular task (e.g., step, operation, decision, sub-process, training of a machine learning model using training data, etc.) may impact the number of processing units 310 the given task is distributed across. In other words, the complexity of an operation impacts the number of nodes (processing units 310) of a neural network across which operation is distributed. While computational throughput increases with the number of processing units 310 a given task is distributed across, so does resulting power consumption. Accordingly, power constraints may also impact the number of processing units 310 a given task is distributed across. Different factors, e.g., such as consumption and computational throughput, may thereby be weighed against each other to determine the desired number of processing units 310 a given task should be distributed across.

It follows that various ones of the processing units 310 and components therein are connected to each other and able to communicate with each other. Information shared between each of the processing units 310 may be used to determine if a particular request (e.g., data request) should be distributed across two or more of the processing units 310. For example, the predicted data access times associated with a data request may be undesirably high. In response, one or more instructions may be sent, causing the data request to be distributed across additional ones of the processing units 310. As a result, additional portions of the overarching data request are performed in parallel, thereby reducing data access times overall. It follows that in some approaches, the processor 312 and coprocessor 314 may operate together to perform various operations. It should also be noted that the term “data request” is in no way intended to be limiting and may involve any desired type of operation.

Each of the processing units 310 are configured to be able to receive and process at least a portion of a request. It follows that a data request received at the distributed processing module 302 may be delivered directly to any one of the processing units 310 therein. In some implementations data requests are directed to a specific one of the processing units 310. For instance, a predetermined one of the processing units 310 may have a higher computational throughput which allows the predetermined processing unit to more efficiently receive a request, evaluate the request, and distribute one or more portions of the request across the neural network of distributed processing module 302.

A processing unit 310 that initially receives a data request may inspect the request and make determinations based on the size, type, number, etc., of request(s) received. For instance, the processing unit 310 that receives a data request may evaluate details of the data request in order to determine whether the request (e.g., compute operation) should be distributed across other ones of the processing units 310 in the neural network that extends across the distributed processing module 302, e.g., as will soon become apparent.

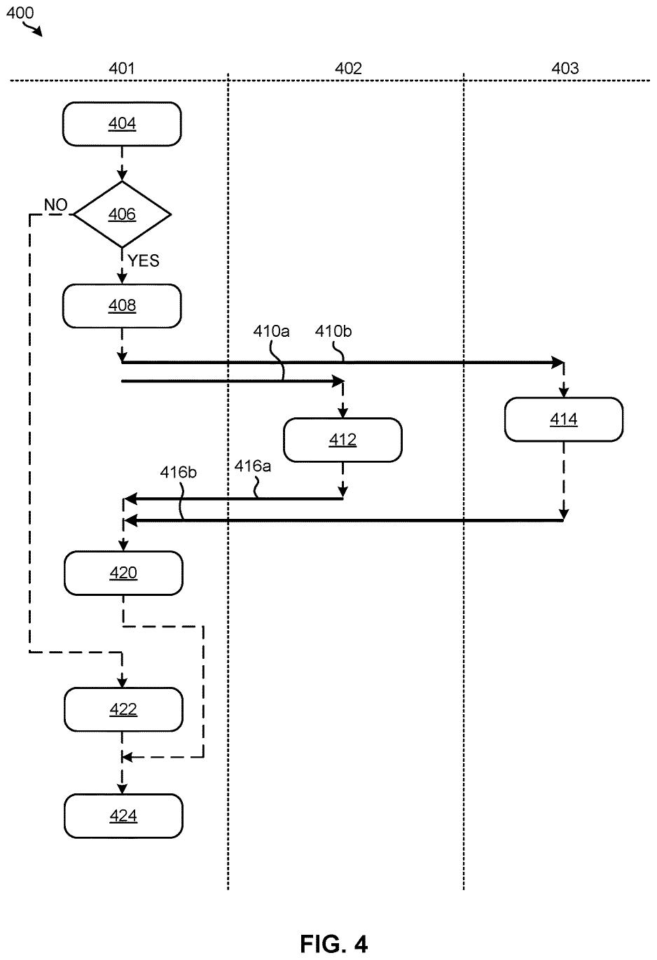

FIG. 4, a flowchart of a computer-implemented method 400 for satisfying requests using a distributed processing module is shown according to one implementation. The method 400 may be performed in accordance with any of the environments depicted in FIGS. 1A-3, among others, in various embodiments. Of course, greater or fewer operations than those specifically described in FIG. 4 may be included in method 400, as would be understood by one of skill in the art upon reading the present descriptions.

Each of the steps of the method 400 may be performed by any suitable component of the operating environment. For example, each of the nodes 401, 402, 403 shown in the flowchart of method 400 may correspond to one or more processing units positioned at a different location in a distributed processing module. Moreover, each of the processing units may be neural processors configured to communicate with each other, thereby forming a neural network, e.g., as would be appreciated by one skilled in the art after reading the present description.

The processing units, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As mentioned above, FIG. 4 includes different nodes 401, 402, 403, each of which represent one or more processors, controllers, computers, etc., positioned at a different location in a distributed processing module. For instance, node 401 may include one or more neural processors which are electrically coupled to various other neural processors of a distributed processing module (e.g., see distributed processing module 302 of FIG. 3 above). Nodes 402 and 403 may each similarly include one or more processors which are electrically coupled to the remaining neural processors of the distributed processing module (e.g., see distributed processing modules 302 of FIG. 3 above). Accordingly, commands, data, requests, etc. may be sent between each of the nodes 401, 402, 403 depending on the approach. Moreover, it should be noted that the various processes included in method 400 are in no way intended to be limiting, e.g., as would be appreciated by one skilled in the art after reading the present description. For instance, data sent from node 402 to node 403 may be prefaced by a request sent from node 403 to node 402 in some approaches.

Operation 404 of method 400 includes receiving a request. As noted above, method 400 may be performed by any suitable component of the operating environment. In some implementations, one or more of the operations in method 400 may be performed by one of the processing units in a distributed processing module. For example, the request may be received at one of the processing units 310 of distributed processing module 302 in FIG. 3. The processing unit that receives the request may be assigned to satisfying that request. In other words, the processing unit that receives a particular request is responsible for ensuring the request is successfully performed, e.g., as will be described in further detail below.

Data requests may be directed to different ones of the processing units in a distributed processing module depending on the implementation. For instance, one or more of the processing units may be physically and/or logically configured in a specific manner that improves the efficiency by which the processing units are able to evaluate data requests and distribute portions thereof. In other implementations, each data request may indicate a specific one of the processing units the respective data request should be received by. In still other implementations, a data request may be sent to one of the processing units that is randomly chosen, a processing unit selected by the user, etc.

The type of request that is received may also vary depending on the situation. For instance, a given system receives different types of requests during operation. However, systems themselves may also differ in type, and so different types of systems may receive different types (e.g., subsets) of requests. It follows that while certain types of requests (e.g., “data requests”) have been used in various implementations herein, this is in no way intended to be limiting. Any of the implementations herein may be used for any desired type of received request (e.g., instruction(s), command procedure(s), queries, etc.).

As noted above, the processing unit that receives the data request preferably evaluates the request. Evaluating the data request reveals details about the request that may be used to satisfy the request in an efficient manner. For instance, evaluating a data request may reveal that the request can be split into multiple portions and distributed across other processing units. Again, this desirably improves operating efficiency by allowing for different portions of the same request to be performed simultaneously and in parallel. It follows that operation 406 includes determining whether at least a portion of the data request should be processed by one or more of the remaining processing units.

Operation 406 may be performed differently depending on the implementation. For instance, a predicted amount of latency associated with the received data request may be compared to a predetermined threshold. The type of data request may also impact the number of processing units that are used to satisfy the data request in a given implementation. In still other implementations, a backlog of data requests may at least somewhat impact the number of processing units that are used to satisfy a current data request. The number and/or type of processing units themselves may impact whether and/or how a data request is distributed.

In response to determining that at least a portion of the data request should be processed by at least one additional one of the remaining processing units, method 400 proceeds from operation 406 to operation 408. There, operation 408 includes dividing the data request into a desired number of portions. As noted above, the number of portions a given data request is divided into may depend on any number of factors, e.g., such as the type of data request, the number of available processing units, user input, etc.

The process of dividing the data request into different portions may also vary depending on the implementation. For instance, in some implementations a data request may be divided into portions of equal size. In other words, the data request may be divided into portions that correspond to a same amount of work for a processing unit. In other implementations, a data request may be divided into a number of portions equal to a number of sub-processes included in the given data request. It follows that the data request may be divided into any number of portions, each portion having any desired size.

Operation 410 further includes transferring the portions of the data request to one or more of the remaining processing units. Again, a data request may be any form of operation, command, predetermined procedure, etc., which may be divided into any desired number of portions. Accordingly, arrowed lines 410a and 410b extend from the original node 401 to nodes 402 and 403, respectively. While FIG. 4 only shows portions of the data request being sent to nodes 402 and 403, this is in no way intended to be limiting, but rather is presented by way of example to illustrate what may be sent to all processing units, the majority of the processing units, a predetermined subset of the processing units, etc., of a distributed neural processing module.

Portions of the data request may be transferred to processing units in some approaches by reassigning the individual portions of the data request to the respective processing units. It follows that one or more signals (e.g., instructions) may actually be sent from the processing unit that originally received and evaluated the data request.

Nodes 402 and 403 thereby each receive a portion of the data request originally received at node 401 (e.g., see operation 404 above). In response to receiving the portions of the data request, nodes 402 and 403 each satisfy their respective portion of the data request. See operations 412 and 414, respectively. Depending on the type of data request originally received and/or the specific portions of the originally received data request that are actually sent to each of the supplemental processing units at nodes 402, 403, operations 412 and 414 may involve performing various different sub-operations. For example, operations 412 may involve a data read operation which results in node 402 sending a data request to storage, while operation 414 involves a data write operation which results in node 403 sending a data write command to storage.

In response to satisfying the various portions of the originally received data request, information may be sent back to node 401. Accordingly, operation 416 includes returning information (e.g., results of performing the assigned portion of the data request, an indication that the assigned portion of the data request was successfully completed, etc.). Each of the processing units is sending a portion of the total request, and therefore arrowed lines have been labeled 416a and 416b to distinguish between the different portions being received at node 401 from each of nodes 402 and 403, respectively.

In some implementations the information is returned to the processing unit that originally assigned the portion of the data request. A processing unit that originally received and evaluated a data request to create portions may be able to compile the various completed portions received from the numerous other processing units in an efficient manner by capitalizing on processing that was previously performed (e.g., to form the various portions and assign them).

However, in some implementations, the completed portions may be sent to at another processing unit, location, component, etc. Again, processing units may be configured differently from each other to create different characteristics thereof. It follows that a subset of the processing units may be physically and/or logically configured to more efficiently compile, evaluate, present, etc. results of the specific data request that was originally received. Operation 416 may thereby include returning information to one or more predetermined processing units. In still other implementations, the data request may specify an intended location that results are sent. Some data requests may even specify the number and/or type of processing units the portions of the request are distributed across.

Operation 420 further includes compiling information received from the various processing units used to satisfy portions of the data request. In other words, operation 420 includes merging all completed portions of the data request to produce a final result achieved as a result of satisfying the data request originally received in operation 404.

Returning now to operation 406, method 400 alternatively proceeds directly to operation 422 in response to determining that the data request should not be divided into portions. There, operation 422 includes using the processing unit that originally received the data request to satisfy (e.g., perform) the request. In some instances, a data request may have a low computational overhead and it may be determined that it is more computationally efficient to perform the data request using a single processing unit rather than dividing the data request into different portions, sending the portions to different processing units, receiving the completed portions, and then merging them back together to actually satisfy the original data request.

From each of operation 420 and 422, the flowchart of FIG. 4 proceeds to operation 424, whereby method 400 may end. However, it should be noted that although method 400 may end upon reaching operation 424, any one or more of the processes included in method 400 may be repeated in order to process additional requests that are received. In other words, any one or more of the processes included in method 400 may be repeated for subsequently received requests (e.g., data operations, instructions, command procedures, etc.)

It follows that method 400 is able to utilize a scalable and distributed processing module to improve the efficiency by which various requests are performed. The number of processing units (e.g., see processing units 310 of FIG. 3) can be selectively adjusted to configure the distributed processing module for a particular implementation. For instance, operating procedures may dictate specific processing times (e.g., amounts of latency), power consumption ranges, computational throughputs, etc. be implemented. The number of processing units and/or the configurations thereof may thereby be adjusted to achieve a resulting processing module that is able to operate as desired.

For example, a data operation received may indicate an acceptable amount of latency that may be experienced while implementing the data operation. In some implementations, the distributed processing module may use this information to determine a desired number of processing units to spread the data operation across. Increasing the number of active processing units typically reduces latency, while decreasing the number of active processing units reduces power consumption. As noted above, the benefits of compute throughput and power consumption may be weighed to determine an implementation that performs as desired for a given implementation.

For example, this weighing of performance characteristics may be implemented in operation 406 to determine whether a data request should be processed by one or more of the remaining processing units and how many. For instance, the distribution metrics implemented may change based on the particular request being processed. Processing units that are not used to perform at least a portion of a request may remain in a low power mode, very low power mode, completely powered down (e.g., turned off), etc., depending on a desired power consumption profile for the distributed processing module. Implementations herein improve computational efficiency, but it also improves power consumption by introducing the ability to selectively activate the various units based on the particular request and/or portions thereof.

It should be noted that any of the approaches included herein may be implemented as a system, a method, and/or a computer program product at any possible technical detail level of integration. The computer program product may include a computer readable storage medium (or media) having computer readable program instructions thereon for causing a processor to carry out aspects of any of the implementations included herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of any of the implementations herein may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of any of the implementations herein.

Aspects are described herein with reference to flowchart illustrations and/or block diagrams of methods, apparatus (systems), and computer program products according to some implementations. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various implementations. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various implementations may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that implementations may be provided in the form of a service deployed on behalf of a customer to offer service on demand.

The descriptions of the various implementations have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

What is claimed is:

1. A system for achieving scalable distributed processing, the system comprising:
a plurality of processing units electrically coupled to each other, each of the processing units including:
a processor, and
random-access memory,
wherein at least one of the processing units is configured to:
receive a data request;
determine whether at least a portion of the data request should be processed by one or more remaining processing units; and
in response to determining that at least a portion of the data request should be processed by the one or more remaining processing units, transfer the portion of the data request to the one or more remaining processing units.

2. The system of claim 1, wherein each of the one or more remaining processing units is further configured to:
receive the portion of the data request from the at least one of the processing units;
satisfy the received portion of the data request; and
transfer results of satisfying the received portion of the data request to the at least one of the processing units.

3. The system of claim 1, wherein each of the one or more remaining processing units is further configured to:
receive the portion of the data request from the at least one of the processing units;
satisfy the received portion of the data request; and
transfer results of satisfying the received portion of the data request to a specific one of the processing units other than the at least one of the processing units.

4. The system of claim 3, wherein the specific one of the processing units is identified in the given data request.

5. The system of claim 1, wherein the host processor, and random-access memory of each of the processing units are positioned on a same die.

6. The system of claim 5, wherein at least two of the processing units are electrically coupled to each other by a parallel bus.

7. The system of claim 1, wherein the random-access memory includes one or more types of non-volatile random access memory (NVRAM) selected from the group consisting of: magnetoresistive random-access memory (MRAM), resistive random-access memory (RRAM), and phase change memory.

8. The system of claim 7, wherein cells in the NVRAM are configured as (i) analog multi-bit storage elements.

9. The system of claim 7, wherein cells in the NVRAM are configured as analog adders and/or multipliers.

10. The system in claim 7, wherein cells in the NVRAM are configured as: analog multi-bit storage elements, and computing elements.

11. The system of claim 1, wherein the processor includes a host processor and a co-processor

12. The system of claim 11, wherein the plurality of coprocessors form at least a portion of a distributed neural network.

13. The system of claim 1, wherein one or more of the processing units are physically configured differently than a remainder of the processing units, each of the one or more processing units being physically configured to perform specialized portions of data requests.

14. A method for achieving scalable distributed processing, the method comprising:
Receiving, at a given one of a plurality of processing units, a data request, the plurality of processing units being coupled to each other, wherein each of the processing units includes:
a processor, and
random-access memory;
determining, by the given one of the plurality of processing units, whether at least a portion of the data request should be processed by one or more remaining processing units; and
in response to determining that at least a portion of the data request should be processed by the one or more remaining processing units, transferring by the given one of the plurality of processing units, the portion of the data request to the one or more remaining processing units.

15. The method of claim 14, the method further comprising:
receiving a portion of a second data request from an initial processing unit that originally received the second data request;
satisfying the received portion of the second data request; and
transferring results of satisfying the received portion of the second data request to the initial processing unit.

16. The method of claim 14, wherein the host processor, and random-access memory of each of the processing units are positioned on a same die, wherein at least two of the processing units are electrically coupled to each other by a parallel bus.

17. The method of claim 14, wherein the random-access memory includes one or more types of non-volatile random access memory (NVRAM) selected from the group consisting of: magnetoresistive random-access memory (MRAM), resistive random-access memory (RRAM), and phase change memory.

18. The method of claim 14, wherein one or more of the processing units are physically configured differently than a remainder of the processing units, each of the one or more processing units being physically configured to perform one or more specialized portions of received data requests.

19. A non-transitory computer readable medium having stored thereon, software instructions that, when executed by a processor of a given one of a plurality of processing units, cause the processor of the given processing unit to:
receive, by the given processing unit, a data request, the plurality of processing units being coupled to each other by a bus, wherein each of the processing units includes:
a host processor, and
random-access memory;
determine, by the given processing unit, whether at least a portion of the data request should be processed by one or more remaining processing units; and
in response to determining that at least a portion of the data request should be processed by the one or more remaining processing units, transfer, via the bus, the portion of the data request to the one or more remaining processing units.

20. The non-transitory computer readable medium of claim 19, the software instructions further causing the processor of the given processing unit to:
receive, by the given processing unit, a portion of a second data request from an initial processing unit that originally received the second data request;
satisfy, by the given processing unit, the received portion of the second data request; and
transfer, via the bus, results of satisfying the received portion of the second data request to the initial processing unit,
wherein the host processor, and random-access memory of each of the processing units are positioned on a same die, and
wherein the random-access memory includes one or more types of non-volatile random access memory (NVRAM) selected from the group consisting of: magnetoresistive random-access memory (MRAM), resistive random-access memory (RRAM), and phase change memory.
